(19) United States
(12) Patent Application Publication
(10) Pub. No.: US 2020/0380420 A1
(43) Pub. Date: Dec. 3, 2020

(54) METHOD AND SYSTEM FOR DATA COMMUNICATION

(71) Applicant: Bank of America Corporation, Charlotte, NC (US)

(72) Inventor: Michael J. Sbandi, Charlotte, NC (US)

(21) Appl. No.: 16/428,075

(22) Filed: May 31, 2019

(51) Int. Cl. G06N 20/10; G06N 3/08; G06N 3/04

(52) U.S. Cl. CPC G06N 20/10; G06N 3/0454; G06N 3/088

(57) ABSTRACT

Methods, systems, and computing platforms for data communication are disclosed. Computing platforms may be configured to electronically process with a machine learning controller, a set of network system diagrams to create a set of virtual node system data. The computing platform(s) may be configured to electronically create a computer readable database including a plurality of network record connections based on the set of virtual node system data. The computing platform(s) may be configured to electronically process the computer readable database to output a set of cyber-vector entryways. The computing platform(s) may be configured to electronically process the set of cyber-vector entryways with the machine learning controller based on a machine learning training data set of centrality of nodes to output a set of most probable cyber-vector routing conduits. The computing platform(s) may be configured to electronically output the set of most probable cyber-vector routing conduits to a graphical display screen.

### FIELD OF THE DISCLOSURE

The present disclosure relates to methods, systems, and computing platforms for data communication with machine learning.

### BACKGROUND

In the internet-of-things era, many digital products can be connected to the internet. Enterprise organizations utilize various computing infrastructure to make decisions and trigger actions. The computing infrastructure may include computer servers, computer networks, and sensors. Such an environment may include the Internet of Things (IoT). Often time, an IoT environment generates a plethora of raw data that can overwhelm an enterprise organization. As a result, decision-making for a response to cyberattacks may be hindered, slowed, or cumbersome. Undetected cyberattacks are even more concerning. As the digital economy continues to develop, cybersecurity has become a formidable task in the internet-of-things era.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

One aspect of the present disclosure relates to a system configured for data communication. The system may include one or more hardware processors configured by machine-readable instructions. The processor(s) may be configured to electronically process with a machine learning controller, a set of network system diagrams to create a set of virtual node system data. The processor(s) may be configured to electronically create a computer readable database including a plurality of network record connections based on the set of virtual node system data. The processor(s) may be configured to electronically process the computer readable database to output a set of cyber-vector entryways data. The processor(s) may be configured to electronically process the set of cyber-vector entryways data with the machine learning controller based on a machine learning training data set of centrality of nodes to output a set of most probable cyber-vector routing conduits. The processor(s) may be configured to electronically output the set of most probable cyber-vector routing conduits to a graphical display screen.

In some implementations of the system and method, the processor(s) may be configured to process the data with a deep machine learning controller.

In some implementations of the system and method, the processor(s) may be configured to process the machine learning training data including at least one chain of attack attribute data element. In some implementations of the system and method, the processor(s) may be configured to process the machine learning training data including at least one likelihood of attack attribute data element. In some implementations of the system and method, the processor(s) may be configured to process the machine learning training data including at least one data type at risk attribute data element. In some implementations of the system and method, the processor(s) may be configured to process the machine learning training data including at least one threat actor capability attribute data element.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of [symbol] [symbol] [symbol] n [symbol] and [symbol] he [symbol] nclude plural referents unless the context clearly dictates otherwise.

### BRIEF DESCRIPTION OF THE DRAWINGS

FIG. 1 illustrates a schematic diagram of a digital computing environment in which certain aspects of the present disclosure may be implemented.

FIG. 2 is an illustrative block diagram of workstations and servers that may be used to implement the processes and functions of certain embodiments of the present disclosure.

FIG. 3 illustrates a system configured for data communication, in accordance with one or more implementations.

FIGS. 4A and 4B illustrate a method for data communication, in accordance with one or more implementations.

FIG. 5 is an illustrative functional block diagram of a neural network that may be used to implement the processes and functions, in accordance with one or more implementations.

FIG. 6 is an illustrative block diagram of a point of interest network map that may be used to implement the processes and functions of certain embodiments.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

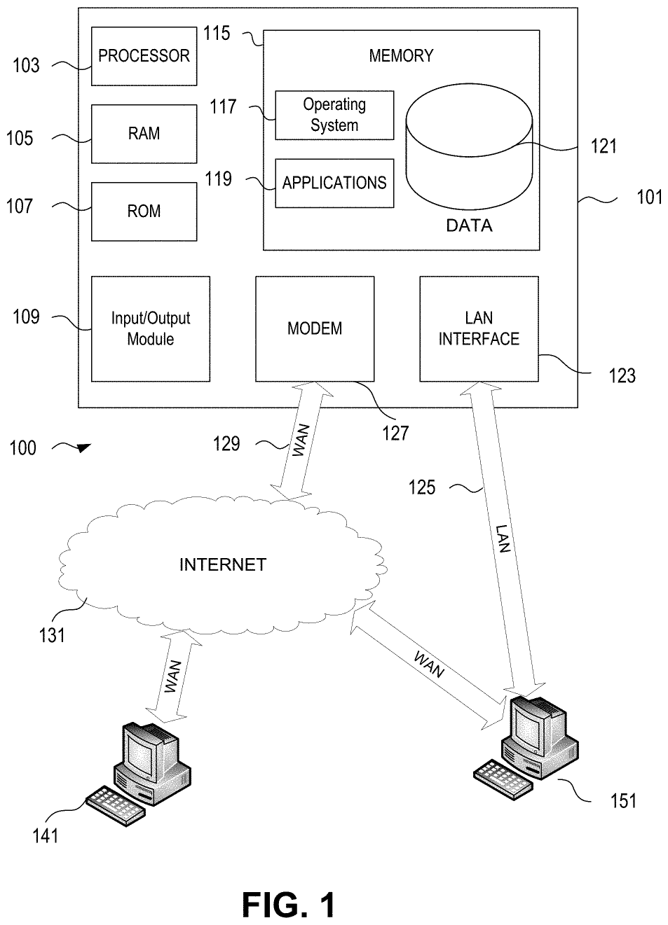

FIG. 1 illustrates a system 100 block diagram of a specific programmed computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide computer readable instructions to processor 103 for enabling server 101 to perform various technologic functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with vendors and patrons, allowing functional interoperability between different elements located at multiple physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, mobile computing devices, e.g., smart phones, wearable computing devices, tablets, distributed computing environments that include any of the above systems or devices, and the like.

The disclosure may be described in the context of computer-executable instructions, such as program modules, being executed by a computer. Generally, program modules include routines, programs, objects, components, data structures, etc. that perform particular tasks or implement particular computer data types. The disclosure may also be practiced in distributed computing environments where tasks are performed by remote processing devices that are linked through a communications network. In a distributed computing environment, program modules may be located in both local and remote computer storage media including memory storage devices.

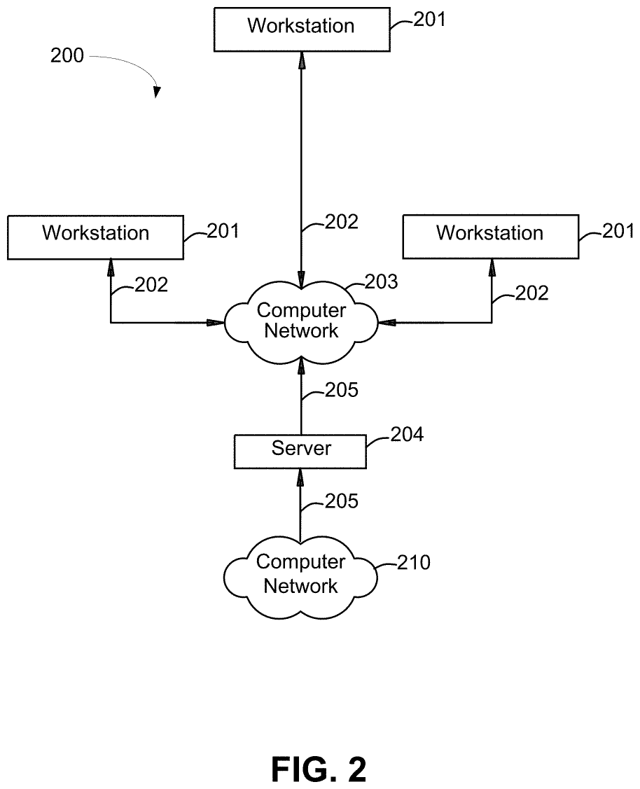

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer networks 203, 210 that is linked via communications links 205 to server 204. In system 200, server 204 may be any suitable server, processor, computer, or data processing device, or combination of the same. Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

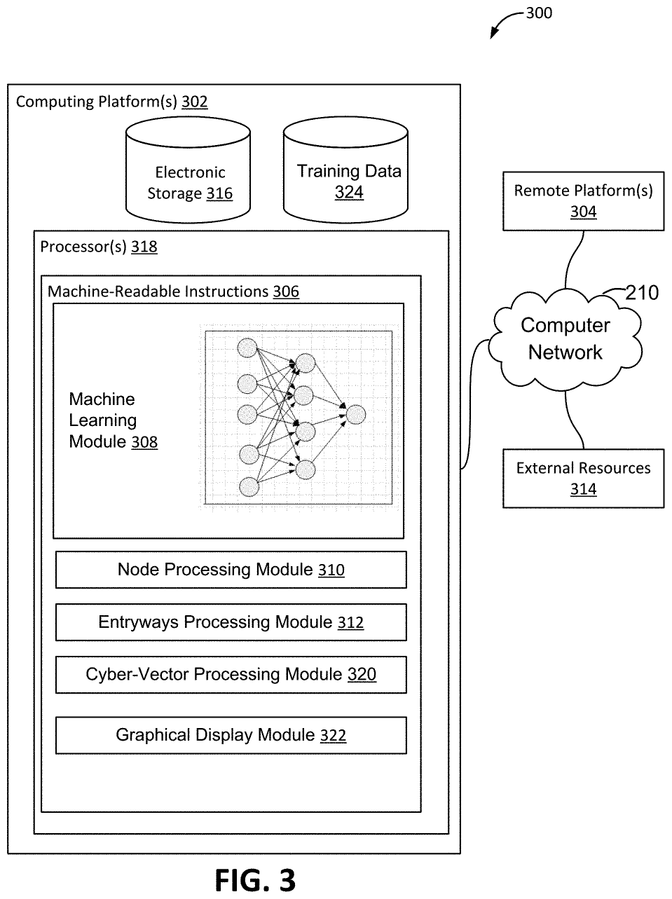

FIG. 3 illustrates a system 300 configured for data communication, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of machine learning module 308, node processing module 310, entryways processing module 312, cyber-vector processing module 320, graphical display module 322 and/or other instruction modules.

The modules 308, 310, 312, 320, 322 and other modules implement APIs containing functions/sub-routines which can be executed by another software system, such as email and internet access controls. API denotes an Application Programming Interface. The systems and methods of the present disclosure can be implemented in various technological computing environments including Simple Object Access Protocol (SOAP) or in the Representational State Transfer (REST). REST is the software architectural style of the World Wide Web. REST APIs are networked APIs that can be published to allow diverse clients, such as mobile applications, to integrate with the organizations software services and content. Many commonly-used applications work using REST APIs as understood by a person of skill in the art.

Some aspects of various exemplary constructions are described by referring to and/or using neural network(s). Machine learning module 308 may be configured to electronically process with a machine deep learning controller. Various structural elements of neural network includes layers (input, output, and hidden layers), nodes (or cells) for each, and connections among the nodes. Each node is connected to other nodes and has a nodal value (or a weight) and each connection can also have a weight.

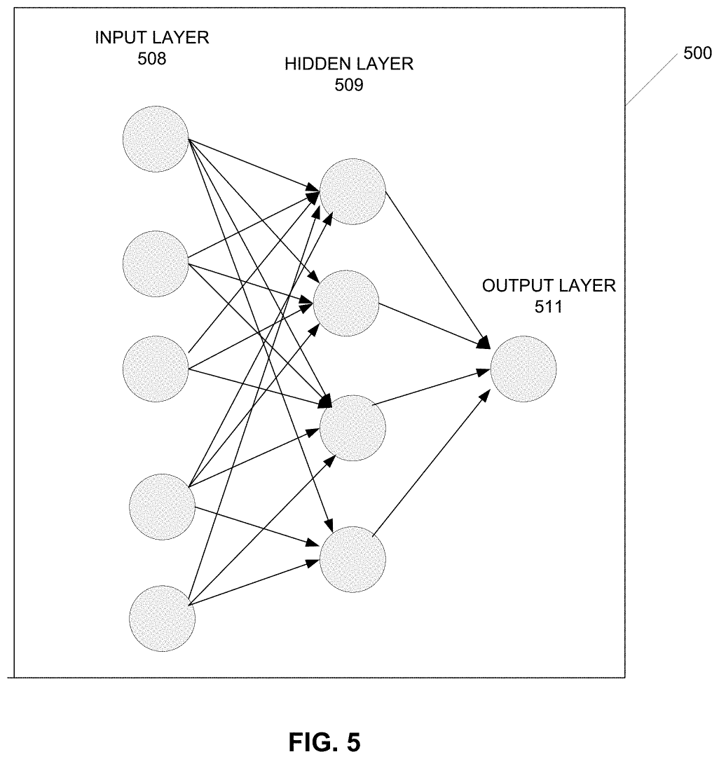

The initial nodal values and connections can be random or uniform. A nodal value/weight can be negative, positive, small, large, or zero after a training session with training data set. System 300, including computer networks 203, 201 may incorporate various machine intelligence (MI) neutral network 500 (see FIG. 5) features of available Tensorflow (https://www.tensorflow.org) or Neuroph software development platforms (which are incorporated by reference hererin). Referring to FIG. 5, neural network 500 is generally arranged in “layers” of node processing units serving as simulated neutrons, such that there is an input layer 508, representing the input fields into the network. To provide the automated machine learning processing, one or more hidden layers 509 with machine learning rule sets processes the input data. An output layer 511 provides the result of the processing of the network data.

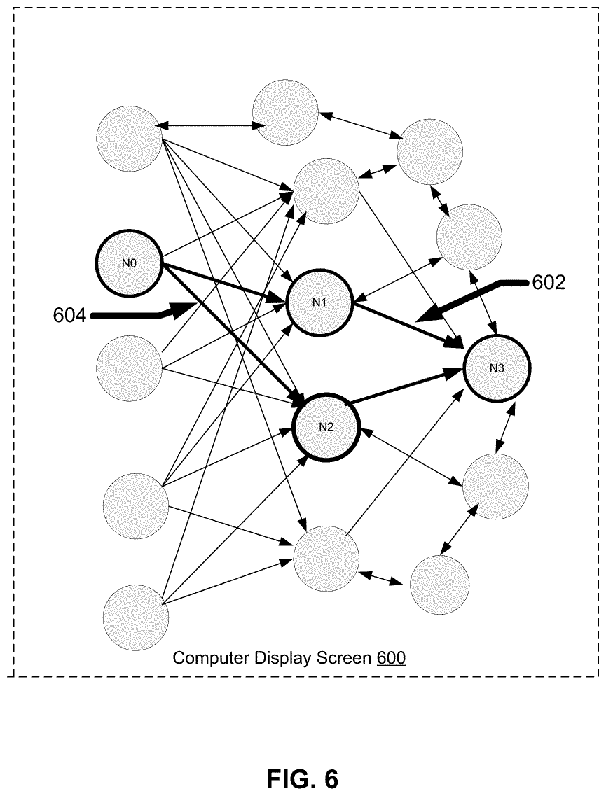

With reference to FIGS. 3 and 6, machine learning module 308 receives a set of network system diagrams to create a set of virtual node system data. System 300 ingests the available systems diagrams for a particular computer service. In some implementations, node processing module 310 electronically creates computer readable database 316 including a plurality of network record connections based on the set of virtual node system data so as to create a database backend and a node network diagram that shows the connections and interdependencies within the network ecosystem, such as network 210. Node processing module 310 calculates and/or determines the criticality (either from the system of record and risk scores, etc.) and the centrality of each node in the network (by using eigenvector and adjacency matrices). This measure of centrality gives an approximation of the importance of the node in the network. The computer readable database 316 may include the “attribute data” including ASCII characters in computer readable form or binary complied data. The ASCII characters or binary data can be manipulated in the software of system 300.

With continued reference to FIG. 3, machine learning module 308 implements deep learning machine learning techniques implementing a representation of learning methods that allows a machine to be given raw data and determine the representations needed for data classification. By using deployment of deep learning software to implement processing, the computing system 300 may eliminate overhead to process the plethora of raw data that can overwhelm the enterprise and/or reduce processing overhead to improve response time and anticipate potential cyberattacks. Deep learning is a subset of machine learning that uses a set of algorithms to model high-level abstractions in data using a deep graph with multiple processing layers including linear and non-linear transformations. While many machine learning systems are seeded with initial features and/or network weights to be modified through learning and updating of the machine learning network, a deep learning network trains itself to identify “good” features for analysis. Using a multilayered architecture, machines employing deep learning techniques can process raw data better than machines using conventional machine learning techniques. Examining data for groups of highly correlated values or distinctive themes is facilitated using different layers of evaluation or abstraction.

Deep learning ascertains structure in data sets using backpropagation algorithms which are used to alter internal parameters (e.g., node weights) of the deep learning machine. Deep learning machines can utilize a variety of multilayer architectures and algorithms. While machine learning, for example, involves an identification of features to be used in training the network, deep learning processes raw data to identify features of interest without the external identification.

In some implementations, machine learning module 308, deep learning in a neural network environment includes numerous interconnected nodes referred to as neurons. Input neurons, activated from an outside source, activate other neurons based on connections to those other neurons which are governed by the machine parameters. A neural network behaves in a certain manner based on its own parameters. Learning refines the machine parameters, and, by extension, the connections between neurons in the network, such that the neural network behaves in a desired manner.

One of implementations machine learning module 308 include deep learning technology that may utilize a convolutional neural network segments data using convolutional filters to locate and identify learned, observable features in the data. Each filter or layer of the CNN architecture transforms the input data to increase the selectivity and invariance of the data. This abstraction of the data allows the machine to focus on the features in the data it is attempting to classify and ignore irrelevant background information.

Deep learning operates on the understanding that many datasets include high level features which include low level features. While examining an image, for example, such as, computer system diagrams, rather than looking for an object, it is more efficient to look for edges which form motifs which form parts, which form the object being sought. These hierarchies of features can be found in many different forms of data such as speech and text, etc.

In some implementations, learned observable features include objects and quantifiable regularities learned by the machine during supervised learning. A machine provided with a large set of well classified data is better equipped to distinguish and extract the features pertinent to successful classification of new data. A deep learning machine that utilizes transfer learning may properly connect data features to certain classifications affirmed by a human expert. Conversely, the same machine can, when informed of an incorrect classification by a human expert, update the parameters for classification. Settings and/or other configuration information, for example, can be guided by learned use of settings and/or other configuration information, and, as a system is used more (e.g., repeatedly and/or by multiple users), a number of variations and/or other possibilities for settings and/or other configuration information can be reduced for a given example training data set.

An example deep learning neural network can be trained on a set of expert classified data, for example. This set of data builds the first parameters for the neural network, and this would be the stage of supervised learning. During the stage of supervised learning, the neural network can be tested whether the desired behavior has been achieved.

Once a desired neural network behavior has been achieved (e.g., a machine learning module 308 has been trained to operate according to a specified threshold, etc.), the machine learning module 308 can be deployed for use (e.g., testing the machine with “real” data, etc.). During operation, neural network classifications can be confirmed or denied (e.g., by an expert user, expert system, reference database, etc.) to continue to improve neural network behavior. The example neural network is then in a state of transfer learning, as parameters for classification that determine neural network behavior are updated based on ongoing interactions. In certain examples, the neural network can provide direct feedback to another process. In certain examples, the neural network outputs data that is buffered (e.g., via the cloud, etc.) and validated before it is provided to another process.

In some implementations, machine learning module 308 may be configured to electronically process with the machine learning controller. Machine learning module 308 may identify the possible threat vectors (e.g. network pathways) leading to the most central assets (such as, pathways from entry-point, through different containers to the central asset e.g. steps in the cyber chain).

In some implementations, entryways processing module 312 identifies possible network entry points and determines the most likely entry points using machine learning module 308 (using test data set 324 that analyzes certain attributes). In one implementation, training data set 324 can include information if the central node is connected to a web-facing application anywhere within the system.

In some implementations, cyber-vector processing module 320 implements suitable linear programming algorithms to model possible threat combinations against each cyber-vector entryway in the data set. Cyber-vector processing module 320 electronically processes the set of cyber-vector entryway data with the machine learning module 308 based on a machine learning training data set 324 of centrality of nodes to create a set of most probable cyber-vector conduits. The factors in the training set data 324 may include sets of myriad possible chain of attacks attribute data, likelihood of attack attribute data, data type at risk attribute data, threat actor capability attribute data, ease of accessibility attribute data, strength of mitigating controls attribute data so as to determine which cyber-vector entryways are most at risk to a probable cyber-attack. In some implementations, cyber-vector processing module 320 not only looks for possible entry points, but also considers the centrality of containers that could be exploited in subsequent steps of the “cyber kill chain” (e.g. middleware). The cyber kill chain has stages that can be analyzed by cyber-vector processing module 320. The stages range from reconnaissance (often the first stage in a malware attack) to lateral movement (moving laterally throughout the network to get access to more data) to data exfiltration (getting the data out). By way of non-limiting example, some of the cyber-vector conduits could include a phishing attack, denial of service attack, or malware.

In some implementations, graphical display module 322 can generate a graphical report on display 600 that shows a prioritized list of the most central assets (compared to criticality), most likely attack patterns/chained combinations (given their probability of success from the linear optimization models) and the specific pathway(s) through which the attack patterns would reach their intended target. By way of non-limiting example, referring to FIG. 6, potential security at-risk nodes N1, N2, N3 and pathways 602, 604 may be of interest for further analysis. Pathway 602 pertains to node NO, node N1 and N3. Pathway 604 pertains to node NO, node N2 and node N3. The point of interest nodes in the ecosystem network can be displayed on a computer display screen, such as computer 141, 151 (FIG. 1) in a graphical user interface.

System 300 includes module 310 that can receive and process data points from a plurality of nodes from across the enterprise systems of record and via output APIs and implement controls based from results of machine learning module 308.

In some implementations, the machine learning training data 324 may include at least one chain of attack attribute data element. In some implementations, the machine learning training data 324 may include at least one likelihood of attack attribute data element. In some implementations, the machine learning training data 324 may include at least one data type at risk attribute data element. In some implementations, the machine learning training data 324 may include at least one threat actor capability attribute data element. In some implementations, the machine learning training data 324 may include at least one ease of accessibility attribute data element. In some implementations, the machine learning training data 324 may include at least one strength of mitigating controls attribute data element.

In some implementations, system 300 may include an electronic messaging element, such as an API for an electronic mail system to notification of cyber-vector conduits. In some implementations, the machine learning training data 324 may include a threat actor, GPS location attribute data element pertaining to a geo-location of the device accessing the network (global positioning system (GPS) data), and including the time of period of the day (e.g., increments of two, four, or six hours, such morning, afternoon, evening) and other similar data. The GPS location associated with GPS location attribute may have at least the longitude and latitude of the location to linked to a mapping application.

In some implementations, computing platform(s) 302, remote platform(s) 304, and/or external resources 314 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 314 may be operatively linked via some other communication media.

A given remote platform 304 may include one or more processors configured to execute computer program modules. The computer program modules may be configured to enable an expert or user associated with the given remote platform 304 to interface with system 300 and/or external resources 314, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 314 may include sources of information outside of system 300, external entities participating with system 300, and/or other resources. In some implementations, some or all of the functionality attributed herein to external resources 314 may be provided by resources included in system 300.

Computing platform(s) 302 may include electronic storage 316, 324, one or more processors 318, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 316, 324 may comprise non-transitory storage media that electronically stores information. The electronic storage media of electronic storage 316, 324 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 316 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 316, 324 may include one or more virtual storage resources (e.g., cloud storage, a virtual private network, and/or other virtual storage resources). Electronic storage 316, 324 may store software algorithms, information determined by processor(s) 318, information received from computing platform(s) 302, information received from remote platform(s) 304, and/or other information that enables computing platform(s) 302 to function as described herein.

Processor(s) 318 may be configured to provide information processing capabilities in computing platform(s) 302. As such, processor(s) 318 may include one or more of a digital processor, an analog processor, a digital circuit designed to process information, an analog circuit designed to process information, a state machine, and/or other mechanisms for electronically processing information. Although processor(s) 318 is shown in FIG. 3 as a single entity, this is for illustrative purposes only. In some implementations, processor(s) 318 may include a plurality of processing units. These processing units may be physically located within the same device, or processor(s) 318 may represent processing functionality of a plurality of devices operating in coordination. Processor(s) 318 may be configured to execute modules 308, 310, and/or 312, and/or other modules. Processor(s) 318 may be configured to execute modules 308, 310, and/or 312, and/or other modules by software; hardware; firmware; some combination of software, hardware, and/or firmware; and/or other mechanisms for configuring processing capabilities on processor(s) 318. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 320 and/or 322 are illustrated in FIG. 3 as being implemented within a single processing unit, in implementations in which processor(s) 318 includes multiple processing units, one or more of modules 308, 310, 312, 320, and/or 322 may be implemented remotely from the other modules. The description of the functionality provided by the different modules 308, 310, 312, 320 and/or 322 described below is for illustrative purposes, and is not intended to be limiting, as any of modules 308, 310, 312, 320 and/or 322 may provide more or less functionality than is described. For example, one or more of modules 308, 310, 312, 320 and/or 322 may be eliminated, and some or all of its functionality may be provided by other ones of modules 308, 310, 312, 320 and/or 322. As another example, processor(s) 318 may be configured to execute one or more additional modules that may perform some or all of the functionality attributed below to one of modules 308, 310, 312, 320 and/or 322.

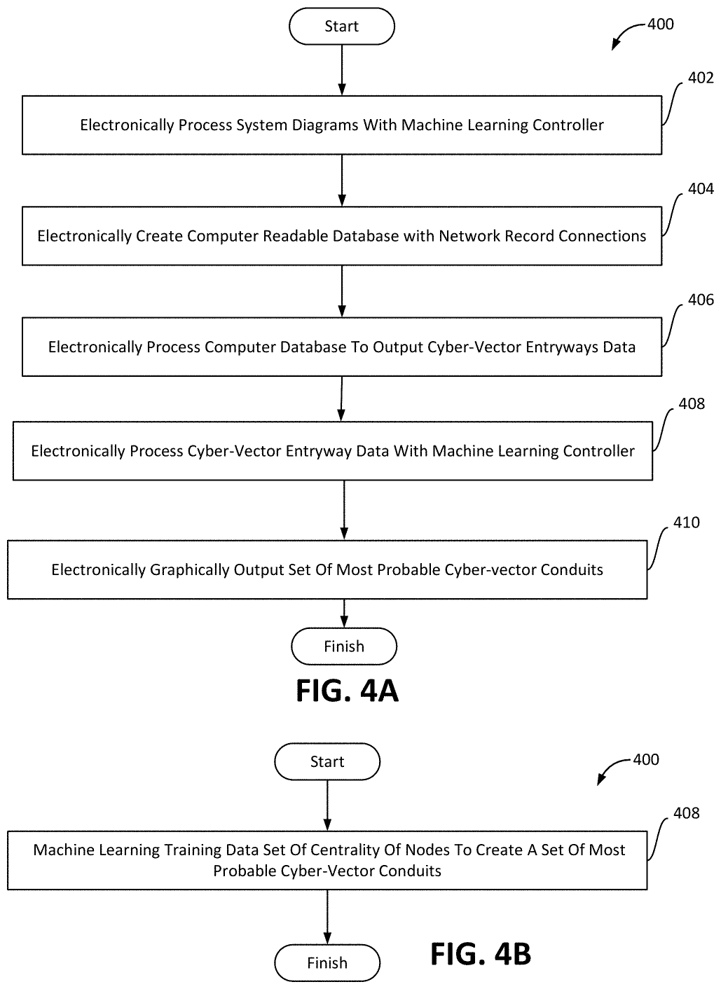

FIGS. 4A and/or 4B illustrates a method 400 for data communication, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIGS. 4A and/or 4B and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on a non-transient electronic storage medium. The one or more processing devices may include one or more devices configured through hardware, firmware, and/or software to be specifically designed for execution of one or more of the operations of method 400.

FIG. 4A illustrates method 400, in accordance with one or more implementations. An operation 402 may include electronically processing with a machine learning controller receiving a set of network system diagrams to create a set of computer readable virtual node system data. Operation 402 may be performed by one or more hardware processors configured by machine-readable instructions including a module that is the same as or similar to machine learning module 308, in accordance with one or more implementations.

An operation 404 may include electronically processing the set of virtual node system data to create a computer readable database 316 including a plurality of network record connections based on the set of virtual node system data. Operation 404 may be performed by one or more hardware processors configured by machine-readable instructions including a module that is the same as or similar to node processing module 310, in accordance with one or more implementations.

An operation 406 may include electronically processing the computer readable database to output a set of cyber-vector entryways. Operation 406 may be performed by one or more hardware processors configured by machine-readable instructions including a module that is the same as or similar to entryways processing module 312, in accordance with one or more implementations.

An operation 410 may include electronically outputting the set of most probable cyber-vector conduits to a graphical display screen 600, such as terminals 141 or 151. Operation 410 may be performed by one or more hardware processors configured by machine-readable instructions including a module that is the same as or similar to module 322, in accordance with one or more implementations.

FIG. 4B illustrates method 400, in accordance with one or more implementations. An operation 408 may include further including electronically processing, with the machine learning controller, the set of cyber-vector entryway data with the machine learning based on a training data set of centrality of nodes to create a set of most probable cyber-vector conduits. Operation 408 may be performed by one or more hardware processors configured by machine-readable instructions including a module that is the same as or similar to cyber-vector processing module 320, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. An electronic computer implemented method of data communication, comprising:
electronically creating a computer readable database including a plurality of network record connections based on a set of virtual node system data;
electronically processing the computer readable database to output a set of cyber-vector entryways data;
electronically processing the set of cyber-vector entryway data with a machine learning controller based on a machine learning training data including a set of centrality of nodes so as to create a set of most probable cyber-vector conduits; and
electronically outputting the set of most probable cyber-vector conduits to a graphical display screen.

2. The method of claim 1, further comprising electronically processing with a machine learning controller, a set of network system diagrams to create the set of virtual node system data.

3. The method of claim 1, wherein the machine learning controller comprises deep machine learning.

4. The method of claim 1, wherein the machine learning training data includes at least one chain of attack attribute data element.

5. The method of claim 1, wherein the machine learning training data includes at least one likelihood of attack attribute data element.

6. The method of claim 1, wherein the machine learning training data includes at least one GPS location attribute data element.

7. A system configured for data communication, the system comprising:
one or more hardware processors configured by machine-readable instructions to:
electronically create a computer readable database including a plurality of network record connections based on a set of virtual node system data;
electronically process the computer readable database to output a set of cyber-vector entryways data;
electronically process the set of cyber-vector entryways data with a machine learning controller based on a machine learning training data including a set of centrality of nodes so as to create a set of most probable cyber-vector conduits; and
electronically output the set of most probable cyber-vector conduits to a graphical display screen.

8. The system of claim 7, wherein the one or more hardware processors are further configured by machine-readable instructions to electronically process with the machine learning controller, a set of network system diagrams to create the set of virtual node system data.

9. The system of claim 7, wherein the machine learning controller comprises deep machine learning.

10. The system of claim 7, wherein the machine learning training data includes at least one chain of attack attribute data element.

11. The system of claim 7, wherein the machine learning training data includes at least one likelihood of attack attribute data element.

12. The system of claim 7, wherein the machine learning training data includes at least one GPS location attribute data element.

13. A computing platform configured for data communication, the computing platform comprising:
a non-transient computer-readable storage medium having executable instructions embodied thereon; and
one or more hardware processors configured to execute the executable instructions to:
electronically create a computer readable database including a plurality of network record connections based on a set of virtual node system data;
electronically process the computer readable database to output a set of cyber-vector entryways data;
electronically process the set of cyber-vector entryway data with a machine learning controller based on a machine learning training data including a set of centrality of nodes so as to create a set of most probable cyber-vector conduits; and
electronically output the set of most probable cyber-vector conduits to a graphical display screen.

14. The computing platform of claim 13, wherein the one or more hardware processors are further configured by the instructions to electronically process with the machine learning controller, a set of network system diagrams to create the set of virtual node system data.

15. The computing platform of claim 13, wherein the machine learning controller comprises deep machine learning.

16. The computing platform of claim 13, wherein the machine learning training data includes at least one chain of attack attribute data element.

17. The computing platform of claim 13, wherein the machine learning training data includes at least one likelihood of attack attribute data element.

18. The computing platform of claim 13, wherein the machine learning training data includes at least one GPS location attribute data element.
